(19) United States
(12) Patent Application Publication
(10) Pub. No.: US 2015/0346874 A1
(43) Pub. Date: Dec. 3, 2015

(54) TOUCH SENSOR

(71) Applicant: SAMSUNG ELECTRO-MECHANICS CO., LTD., Gyeonggi-Do (KR)

(72) Inventors: Jang Ho PARK, Gyeonggi-Do (KR); Yong Suk KIM, Gyeonggi-Do (KR); Jung Ryoul YIM, Gyeonggi-Do (KR); In Hyun JANG, Gyeonggi-Do (KR); Doo Ho PARK, Gyeonggi-Do (KR)

(73) Assignee: SAMSUNG ELECTRO-MECHANICS CO., LTD., Gyeonggi-Do (KR)

(21) Appl. No.: 14/495,142

(22) Filed: Sep. 24, 2014

(30) Foreign Application Priority Data
May 29, 2014 (KR) 10-2014-0065320

(51) Int. Cl. G06F 3/045

(52) U.S. Cl. CPC G06F 3/045

(57) ABSTRACT

Embodiments of the invention provide a touch sensor, including a window substrate, a low reflective layer formed on the window substrate, a first electrode pattern formed on the low reflective layer, an insulating layer formed on the first electrode pattern, and a second electrode pattern formed on the insulating layer and configured to intersect with the first electrode pattern. According to at least one embodiment, the low reflective layer is formed to correspond to a pattern in which the first electrode pattern and the second electrode pattern are overlapped with each other.

### CROSS REFERENCE TO RELATED APPLICATION

This application claims the benefit of and priority under 35 U.S.C. §119 to Korean Patent Application No. KR 10-2014-0065320, entitled “TOUCH SENSOR,” filed on May 29, 2014, which is hereby incorporated by reference in its entirety into this application.

### BACKGROUND

1. Field of the Invention

The invention relates to a touch sensor.

2. Description of the Related Art

In accordance with the growth of computers using a digital technology, devices assisting computers have also been developed, and personal computers, portable transmitters and other personal information processors execute processing of text and graphic using a variety of input devices such as a keyboard and a mouse.

Current techniques for input devices have progressed toward techniques related to high reliability, durability, innovation, designing and processing beyond the level of satisfying general functions. To this end, a touch panel has been developed as an input device capable of inputting information, such as text or graphics, as non-limiting examples.

In addition, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, in the touch panel, research into a technology of forming an electrode pattern using a metal has been actively conducted, as described, for example, in Japanese Patent Document JP2011-175967. As described above, when the electrode pattern is formed using the metal, electric conductivity is excellent and demand and supply are smooth.

### SUMMARY

Accordingly, embodiments of the invention have been made to provide a touch sensor capable of reducing visibility of electrode patterns and to improve performance of the touch sensor by preventing the electrode patterns from being viewed by a reflection by light incident from the outside the case in which the electrode patterns are formed using a metal.

According to various embodiments of the invention, there is provided a touch sensor, which includes a window substrate, a low reflective layer formed on the window substrate, a first electrode pattern formed on the low reflective layer; an insulating layer formed on the first electrode pattern, and a second electrode pattern formed on the insulating layer and formed to intersect with the first electrode pattern. According to at least one embodiment, the low reflective layer is formed to correspond to a pattern in which the first electrode pattern and the second electrode pattern are overlapped with each other.

According to at least one embodiment, the low reflective layer, the first electrode pattern, and the second electrode pattern are formed in a mesh pattern.

According to at least one embodiment, the first electrode pattern has a pitch larger than that of the second electrode pattern.

According to at least one embodiment, the pitch of the first electrode pattern is integer times larger than the pitch of the second electrode pattern.

According to at least one embodiment, the low reflective layer is formed in an insulating pattern, and the touch sensor further comprises a bezel layer formed along a circumference of the window substrate at an outer side of the insulating pattern.

According to at least one embodiment, the first electrode pattern is a sensing electrode and the second electrode pattern is a driving electrode.

According to at least one embodiment, the low reflective layer is made of non-conductive oxide, nitride, insulating ink, or a combination thereof.

According to at least one embodiment, the low reflective layer comprises an aperture ratio less than that of the first electrode pattern and the second electrode pattern.

According to at least one embodiment, the low reflective layer comprises an aperture ratio less than and equal to that of the second electrode pattern and the second electrode pattern has the ape re ratio less than that of the first electrode pattern.

According to at least one embodiment, the aperture ratio of the second electrode pattern is less than 1.05 times of the aperture ratio of the first electrode pattern.

According to at least one embodiment, the second electrode pattern has a pitch less than two times of a pitch of the first electrode pattern.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures, it is to be noted, however, that the Figures illustrate only various embodiments of the invention and are therefore not to be considered limiting of the invention's scope as it may include other effective embodiments as well.

FIG. 1 is a cross-sectional view of a touch sensor according to an embodiment of the invention.

FIG. 2 is a plan view of a first electrode pattern of the touch sensor according to an embodiment of the invention.

FIG. 3 is a plan view of a second electrode pattern of the touch sensor according to an embodiment of the invention.

FIG. 4 is a plan view of overlapped electrode patterns according to an embodiment of the invention.

FIG. 5 is a plan view of a pattern of a low reflective layer of the touch sensor according to an embodiment of the invention.

### DETAILED DESCRIPTION

Advantages and features of the invention and methods of accomplishing the same will be apparent by referring to embodiments described below in detail in connection with the accompanying drawings. However, the invention is not limited to the embodiments disclosed below and may be implemented in various different forms. The embodiments are provided only for completing the disclosure of the invention and for fully representing the scope of the invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the invention. Like reference numerals refer to like elements throughout the specification.

Hereinafter, various embodiments of the invention will be described in detail with reference to the accompanying drawings.

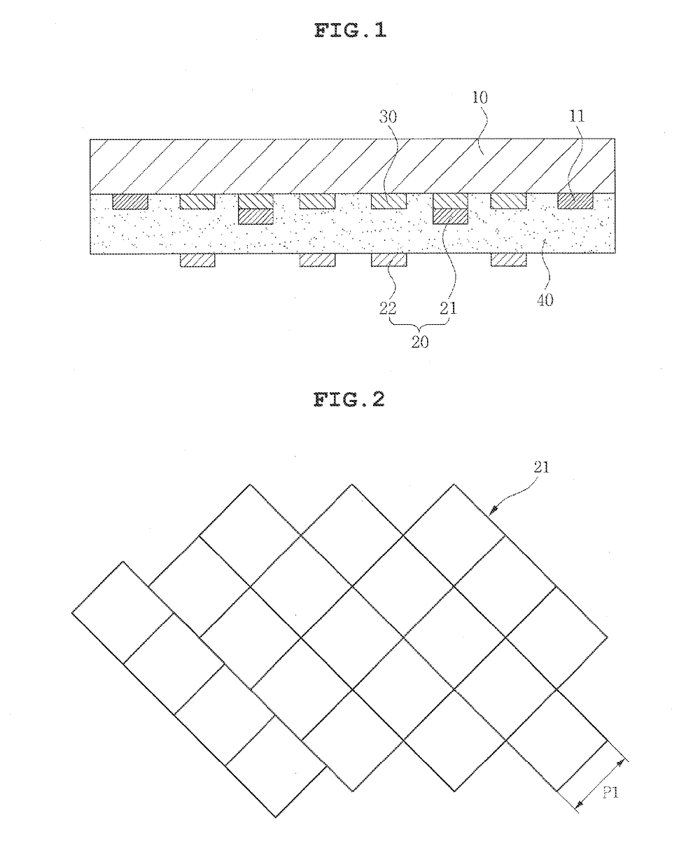

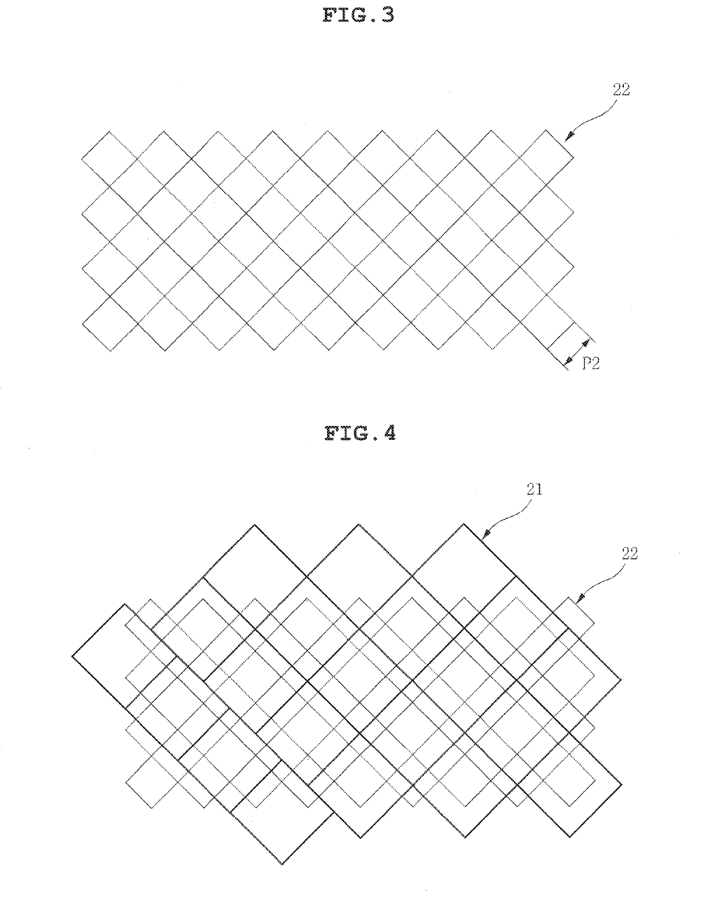

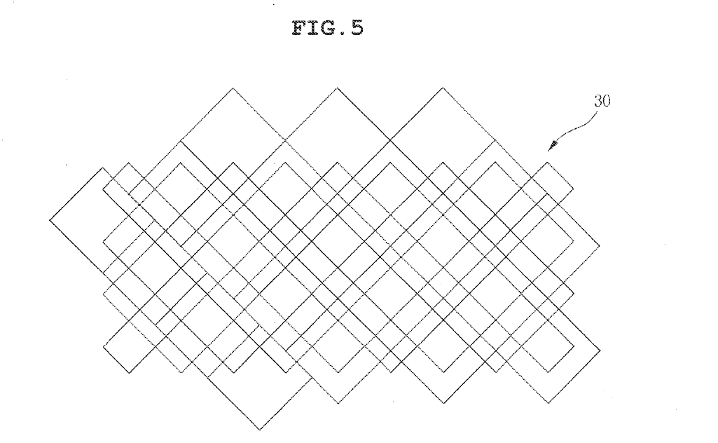

FIG. 1 is a cross-sectional view of a touch sensor according to an embodiment of the invention, FIG. 2 is a plan view of a first electrode pattern 21 of the touch sensor according to an embodiment of the invention, FIG. 3 is a plan view of a second electrode pattern 22 of the touch sensor according to an embodiment of the invention, FIG. 4 is a plan view of overlapped electrode patterns 20 according to an embodiment of the invention, and FIG. 5 is a plan view of a pattern of a low reflective layer 30 of the touch sensor according to an embodiment of the invention.

According to at least one embodiment, a touch sensor includes a window substrate 10, a low reflective layer 30 formed on the window substrate 10, a first electrode pattern 21 formed on the low reflective layer 30, an insulating layer 40 formed on the first electrode pattern 21, and a second electrode pattern 22 formed on the insulating layer 40 and formed to intersect with the first electrode pattern 21. According to at least one embodiment, the low reflective layer 30 is formed to correspond to a pattern in which the first electrode pattern 21 and the second electrode pattern 22 are overlapped with each other.

As shorn in FIG. 1, the window substrate 10, according to at least one embodiment, is formed on the outermost layer of the touch sensor and includes a region touched by a user. The window substrate 10 is generally formed of a reinforced glass, as a non-limiting example, to protect the electrodes in the touch sensor and is formed, for example, by a hard coating or other insulating coatings in addition to a general substrate. In accordance with at least one embodiment, although the case in which the window substrate 10 is disposed at the outermost portion of the touch sensor and includes, an inactive region including a bezel layer 11 in addition to a touched active region will be described by way of example, it may be easily appreciated by those skilled in the art that the window substrate 10 may be described as a separate transparent base substrate coupled to the window substrate 10.

Particularly, in the case in which the separate transparent base substrate (not shown) is used, a material thereof is not particularly limited, as long as it has a predetermined strength or more, but the base substrate may be selectively made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass, as non-limiting examples. In addition, in the case in which the electrode pattern 20 is formed on one surface of the base substrate, in order to improve adhesion between the base substrate and the electrode pattern 20, a surface treatment layer is formed on one surface of the base substrate by performing high frequency treatment or primer treatment, as non-limiting examples.

First, the low reflective layer 30 is formed on one surface of the window substrate 10. The low reflective layer 30 solves a problem that the electrode pattern is viewed by a user by forming the electrode pattern 20 as an opaque metal electrode in the case in which the electrode pattern 20 to be described below is formed. Particularly, in the case in which the electrode pattern 20 is implemented by a metal mesh pattern, there was a problem that the electrode pattern 20 is more easily recognized by the user due to a reflection operation of light by the metal. Therefore, according to at least one embodiment of the invention, the low reflective layer 30 is formed in the same pattern as that of the electrode pattern 20 to be described below in advance, such that visibility of the user due to the reflection of the metal electrode pattern 20 by the light incident from the outside may be reduced.

According to at least one embodiment, the low reflective layer 30 is formed in an insulating pattern in order to prevent an electrical short circuit between the electrode patterns 20 which are stacked. By forming the low reflective layer 30 in the insulating pattern, electrical reliability between the electrode patterns 20 of the touch sensor is maintained. At the same time of forming the low reflective layer 30 in the insulating pattern, a material of the low reflective layer is not particularly limited as long as it has low reflective characteristics capable of reducing reflection of light by the metal, and various, kinds of insulating materials are selectively used.

According to at least one embodiment, a bezel layer 11 is formed on an edge side of one surface of the window substrate 10 together with the low reflective layer 30. The bezel layer 11 has electrode wirings (not shown) for electrically connecting the electrode patterns 20 to each other formed thereon, thereby making it possible to prevent the electrode wirings from being viewed toward the outside Since the low reflective layer 30 is also formed in the insulating pattern, it is formed, for example, at the same time of forming the bezel layer 11, and in consideration of the bezel layer 11 formed of an insulating material, the low reflective layer 30 and the bezel layer 11 are formed, for example, of the same material as each other as long as the material has insulating property. As a result, process complication caused by separately forming the bezel layer 11 and the low reflective layer 30 and degradation in reliability in forming the low reflective layer 30 are prevented. When the bezel layer 11 is formed and the electrode wirings are formed on the bezel layer 11, steps due to the bezel layer 11 generated upon electrically connecting between the electrode patterns 20 and the electrode wirings are removed, such that electrical reliability when the electrode wirings formed on the bezel layer 11 and the electrode patterns 20 are electrically connected to each other are improved.

According to at least one embodiment, the low reflective layer 30 is formed of non-conductive oxide, nitride, insulating ink, or a combination thereof, in addition to those as described above.

According to at least one embodiment, the electrode patterns 20 are directly formed on the low reflective layer 30. According to at least one embodiment, the electrode patterns 20, which serve to generate a signal by an input unit of a touch to allow a touch coordinate to be recognized from a controlling unit (not shown), are formed by a single layer or two layers. Although various embodiments of the invention show a touch sensor including the first electrode pattern 21 and the second electrode pattern 22, which are the two layers as shown in FIG. 1, the number of layers of the electrode pattern 20 is not particularly limited. However, a pattern shape and an arrangement of the low reflective layer 30 formed in the same pattern, according to the number of layers and a shape of the electrode pattern 20 are appropriately changed.

As shown in FIG. 1, the electrode pattern 20 is formed in two layers of the electrode pattern 20 of the first electrode pattern 21 and the second electrode pattern 22 intersecting with the first electrode pattern 21. The first electrode pattern 21 and the second electrode pattern 22 are functioned as a sensing electrode and a driving electrode, respectively, and at least one of the first electrode pattern 21 and the second electrode pattern 22 is formed as the sensing electrode and the other is formed as the driving electrode. However, according to at least one embodiment, the first electrode pattern 21 is referred to as the sensing electrode and the second electrode pattern 22 is referred to as the driving electrode for convenience.

In order to electrically insulate between the electrode patterns 20, when the respective electrode patterns 20 are stacked, an insulating layer 40 is formed between the electrode patterns 20. Although FIG. 1 shows the insulating layer 40, the insulating layer 40, according to at least one embodiment, is formed as the above-mentioned transparent base substrate. According to at least one embodiment, the electrode pattern 20 is formed in a metal mesh pattern (see FIGS. 2 and 3). Because the electrode pattern 20 is formed in the metal mesh pattern, a visibility problem of the electrode pattern 20 has been caused due to an opaque metal. As well, reflectivity caused by general nature of the metal further facilitates visibility of the electrode pattern 20 by the user due to the light incident from the outside.

According to at least one embodiment, by forming the low reflective layer 30 in the same pattern as the above-mentioned electrode pattern 20 between the window substrate 10 and the electrode pattern 20 which are viewed by the user, the visibility of the electrode pattern 20 caused by the reflection of the electrode pattern 20 is reduced.

According to at least one embodiment, the electrode pattern 20 is formed in a mesh pattern using copper (Cu), aluminum (Al), gold (Au), silver (Ag), titanium (Ti), palladium (Pd), chromium (Cr), or a combination thereof. According to at least one embodiment, the mesh pattern has a rectangular shape, a triangular shape, a diamond shape, or other various shapes.

Meanwhile, the electrode pattern 20 is also be made of metal silver formed by exposing/developing a silver salt emulsion layer, a metal oxide such as an indium thin oxide (ITO), as a non-limiting example, a conductive polymer such as poly-3,4-ethylenedioxythiophene/polystyrenesulfonate (PEDOT/PSS), as a non-limiting example, having excellent flexibility and a simple coating process, in addition to the above-mentioned metals.

According to at least one embodiment, the electrode pattern 20 is formed, for example, by a dry process, a wet process, or a direct patterning process, as non-limiting examples. According to at least one embodiment, the dry process includes, for example, a sputtering process, an evaporation process, as non-limiting examples, the wet process include, for example, a dip coating process, a spin coating process, a roll coating process, a spray coating process, as non-limiting examples, and the direct patterning, process includes a screen printing process, a gravure printing process, an inkjet printing process, as non-limiting examples.

According to at least one embodiment, a photosensitive material is applied onto the insulating patterns 30 or the electrode patterns 20 on the substrate sing a photolithograph and light is irradiated thereto using a mask formed in a desired pattern. In this case, a developing process for forming a desired pattern, for example, removing a portion of the photosensitive material to which the light is irradiated using a developer, removing a portion of the photosensitive material to which the light is not irradiated using a developer, as non-limiting, examples, is performed. Then, the photosensitive material is formed in a specific pattern, and the remaining portion is removed by an etchant by using the photosensitive material as a resist. Then, when the photosensitive material is removed, the insulating pattern 30 or the electrode patterns 20 having a desired pattern is manufactured.

According to at least one embodiment, the touch sensor according to an embodiment of the invention forms the low reflective layer 30 having the same mesh pattern as the first electrode pattern 21 and the second electrode pattern 22 in order to reduce the visibility of the electrode patterns 20 (see FIGS. 4 and 5). Particularly, when it is considered that the electrode patterns 20 having the mesh shape are formed of the metal, the entire visibility of the electrode patterns 20 is reduced by preventing the reflection caused by the light incident from the outside and forming the low reflective layer 30 in the same pattern as the electrode patterns 20. Here, the same pattern as the electrode patterns 20 means the same pattern (see FIG. 5) as a pattern (see FIG. 4) on a plane in which the first electrode pattern 21 and the second electrode pattern 22 are overlapped, when the first electrode pattern 21 and the second electrode pattern 22 are formed.

According to at least one embodiment, when a mesh pattern having a pitch of P1 of the first electrode pattern 21 as shown in FIG. 2 and a mesh pattern having a pitch of P2 of the second electrode pattern 22 as shown in FIG. 3 are overlapped, an overlapped mesh pattern as shown in FIG. 4 is formed. In this case, the low reflective layer 30 is formed in a pattern shape including all of the first electrode pattern 21 and the second electrode pattern 22 as shown in FIG. 5. Although not shown, the first electrode pattern 21 or the second electrode pattern 22, which is formed in the mesh pattern are provided with an electrical short circuit part for insulating between the respective electrode patterns 20, when a plurality of electrode patterns 20 are formed to be parallel with each other. The electrical short circuit part is formed by disconnecting metal fine wires forming the mesh pattern in consideration of the visibility of the electrode patterns 20. In this case, a problem that the disconnected portion is noticeably viewed from the entire electrode patterns 20 occurs. However, by forming the low reflective layer 30 in the insulating pattern, which is continuously formed without having the disconnected portion, as described in the embodiment of the invention, the electrode patterns are viewed as a continuous pattern in a view direction in which the user views the touch sensor, such that the visibility of the electrode patterns 20 by the user is reduced.

According to at least one embodiment of the invention, the pitch P1 of the first electrode pattern 21 is formed to be larger than the pitch P2 of the second electrode pattern 22, particularly, is formed to be integer times (e.g., magnitudes) larger than the pitch P2 of the second electrode pattern 22. More specifically, the pitch P2 of the second electrode pattern 22 is formed to be less than two times of the pitch P1 of the first electrode pattern 21. A relationship between pitch widths of the first electrode pattern 21 and the second electrode pattern 22 is to further reduce the visibility of the first electrode pattern 21 and the second electrode pattern 22, which are overlapped with each other. In addition to this, according to an embodiment of the invention, by forming the low reflective layer 30 having the same mesh pattern as the entire electrode patterns 20 including the overlapped electrode patterns 20, the visibility of the electrode patterns 20 is reduced.

According to at least one embodiment, an aperture ratio of the low reflective layer 30 is smaller than the aperture ratio of the first electrode pattern 21 and the second electrode pattern 22. Specifically, the aperture ratio of the low reflective layer 30 is less than or equal to the aperture ratio of the second electrode pattern 22 and the aperture ratio of the second electrode pattern 22 is less than the aperture ratio of the first electrode pattern 21. According to at least one embodiment, the visibility of the electrode patterns 20 is more appropriately reduced by the relationship between the aperture ratios of the low reflective layer 30, the first electrode pattern 21 and the second electrode pattern 22.

As set forth above, according to various embodiments of the invention, the visibility of the electrode patterns of the touch sensor is reduced by the low reflective layer, thereby making it possible to improve the visibility of the touch sensor.

In addition, the pitch of the sensing electrode of the first electrode pattern and the pitch of the driving electrode of the second electrode pattern are formed to have the uniform width, such that efficient operation performance of the touch sensor is implemented. As well, the low reflective layer is formed in the pattern including the respective patterns of the sensing electrode and the driving electrode, such that the visibility by the user is reduced.

In addition, the low reflective layer is formed on the outermost portion of the window substrate of the touch sensor.

In addition, the electrode patterns of the touch sensor are formed in the mesh pattern, such that sensitivity of the touch sensor may be improved and the visibility of the electrode patterns is efficiently secured.

Terms used herein are provided to explain embodiments, not limiting the invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the invention may suitably comprise, consist or consist essentially of the elements disclosed and may be practiced in the absence of an element not disclosed. For example, it can be recognized by those skilled in the art that certain steps can be combined into a single step.

The terms and words used in the specification and claims should not be interpreted as being limited to typical meanings or dictionary definitions, but should be interpreted as having meanings and concepts relevant to the technical scope of the invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the invention has been described in detail, it should be understood that various changes, substitutions, and alterations can be made hereupon without departing from the principle and scope of the invention. Accordingly, the scope of the invention should be determined by the following claims and their appropriate legal equivalents.

What is claimed is:

1. A touch sensor, comprising:
a window substrate;
a low reflective layer formed on the window substrate;
a first electrode pattern formed on the low reflective layer;
an insulating layer formed on the first electrode pattern; and
a second electrode pattern formed on the insulating layer and configured to intersect with the first electrode pattern,
wherein the low reflective layer is formed to correspond to a pattern which the first electrode pattern and the second electrode pattern are overlapped with each other.

2. The touch sensor of claim 1, wherein the low reflective layer, the first electrode pattern, and the second electrode pattern are formed in a mesh pattern.

3. The touch sensor of claim 2, wherein the first electrode pattern has a pitch larger than that of the second electrode pattern.

4. The touch sensor of claim 3, wherein the pitch of the first electrode pattern is integer times larger than the pitch of the second electrode pattern.

5. The touch sensor of claim 1, wherein the low reflective layer is formed in an insulating pattern, and the touch sensor further comprises a bezel layer formed along a circumference of the window substrate at an outer side of the insulating pattern.

6. The touch sensor of claim 2, wherein the first electrode pattern is a sensing electrode and the second electrode pattern is a driving electrode.

7. The touch sensor of claim 6, wherein the low reflective layer is made of non-conductive oxide, nitride, insulating ink, or a combination thereof.

8. The touch sensor of claim 6, wherein the low reflective layer comprises an aperture ratio less than that of the first electrode pattern and the second electrode pattern.

9. The touch sensor of claim 6, wherein the low reflective layer comprises an aperture ratio less than and equal to that of the second electrode pattern and the second electrode pattern has the aperture ratio less than that of the first electrode pattern.

10. The touch sensor of claim 8, wherein the aperture ratio of the second electrode pattern is less than 1.05 times of the aperture ratio of the first electrode pattern.

11. The touch sensor of claim 6, wherein the second electrode pattern has a pitch less than two times of a pitch of the first electrode pattern.
